(19) United States
(12) Patent Application Publication
(10) Pub. No.: US 2015/0087078 A1
(43) Pub. Date: Mar. 26, 2015

(54) WELL SEALS IN PIPETTE WORKSTATIONS

(71) Applicant: Accel Biotech, Inc., Los Gatos, CA (US)

(72) Inventor: Bruce J. Richardson, Los Gatos, CA (US)

(21) Appl. No.: 14/494,817

(22) Filed: Sep. 24, 2014

Related U.S. Application Data
(60) Provisional application No. 61/881,840, filed on Sep. 24, 2013.

(51) Int. Cl. G01N 35/10; B01L 3/02

(52) U.S. Cl. CPC G01N 35/1074; G01N 35/1002; B01L 3/0279; G01N 2035/103; B01L 2200/026; B01L 2200/0642; B01L 2200/0689; B01L 2300/041; B01L 2300/0893; B01L 2300/0858; B01L 2300/123; B01L 2400/049
USPC 436/180; 422/519

(57) ABSTRACT

A pipette workstation of the type dispensing fluids into a microtiter plate with well closure structures that are thimble-shaped members with ridges that form a seal. The closure structures have a beveled nose lower end for self-centering entry into a well with a lower peripheral ridge acting as a first seal. An intermediate peripheral ridge contacts the wall of the well and forms a second seal barrier. An upper peripheral ridge has a diameter that barely enters the well for wedge action stoppage of entry of closure member into the well and further sealing the well. A pipette head with a nozzle array attaches to an array of seals and inserts the seals into wells. The pipette head uses a vacuum force to remove the seals.

### CROSS REFERENCE TO RELATED APPLICATION

This application claims priority from provisional application Ser. No. 61/881,840, filed Sep. 24, 2013.

### TECHNICAL FIELD

The invention relates generally to analytical chemistry processing clinical and research laboratory equipment and, more particularly, to well seals for microtiter plates that can be manipulated by a pipette or a pipette array.

### BACKGROUND ART

Covers for well plates are known. For example, in U.S. Pat. No. 5,604,130 to Warner et al. disclose a cover effective to releasably seal a multiwell container, such as a microtitration plate. Multiwell plates may also be referred to as multiwell plates, microwell plates, microtiter plates, among other names. Such plates commonly have 96 wells, although 12, 24, 48, 384, and 1536 well plates. The cover contains a pad, fashioned from a flexible polymer sheet, and a plurality of resiliently compressible ridges formed on the sheet. The ridges are deformable, such that application of pressure applied to the cover is effective to form a fluid-tight seal between the pad and the well openings. The ridges extend from the pad sufficiently to break the seal upon release of the pressure.

In U.S. Pat. No. 6,500,390 to Boulton et al. disclose a microplate assembly having a multi-well microplate, a plurality of vent caps and a porous vent film. The microplate includes a frame that houses a plurality of open wells in a rectangular array. Vent caps mount on the microplate to seal and vent the wells. When the vent caps are coupled to the wells, an interior volume is formed in each well. The wells function as a vessel for liquid samples that occupy predetermined spaces within the interior volumes. Each liquid sample remains within its predetermined space for all orientations of the microplate assembly. The vent cap has an array of well inserts. Each well insert has a sealing plus and a vent tube. A flexible perforated web interconnects the well inserts to each other. The vent tubes are fixed to the sealing plugs and terminate in a vent. A barrier formed from a plurality of nested flaps resiliently mounts on the vent tube to partially cover the vent.

In a U.S. Pat. No. 7,968,061 to Goodwin discloses a microplate having a plate body with at least one well formed therein, the well having a first open end, a second end, an aperture being formed in the second end, and a side wall extending between the first end and the second end. A membrane extends across the aperture formed in the second end.

An object of the invention was to devise a workstation that seals and covers wells in microtiter plates.

### SUMMARY OF THE INVENTION

The above objective has been met with a apparatus for sealing microtiter plates with well closure structures in a multi-function workstation. Multiwell plates may also be referred to as multiwell plates, microwell plates, microtiter plates, among other names. Such plates commonly have 96 wells, although 12, 24, 48, 384, and 1536 well plates. The workstation has a table for supporting microtiter plates and other fluid receptacles, an arm, and a multi-function head affixed for reciprocal movement along the arm. The workstation combines into a single programmable system the capabilities for automation of a wide range of bioanalytical procedures including, not only sample pipetting, serial dilution, reagent additions, mixing, reaction timing, washing of reaction vessels, and incubation that requires sealing of the reaction vessel with thimble-shaped, ribbed, closure structures of the invention.

The well closure structures are thimble-shaped ridged members or strips of identical members made of yieldable material, such as rubber or soft inert polymer. Each closure structure or seal has spaced apart peripheral ridges that serve to seal wells into which the structure are pushed by a pipette tip. At the downhole closed end of a closure structure a beveled edge nose allows self-centering entry into a well. A lower peripheral ridge terminates the nose and has a diameter that yieldably contacts walls of the well.

An upper peripheral ridge at the top of the closure structure, spaced from the lower ridge, has a yieldable wedge fit into the well and stops entry of the structure after a short distance. An intermediate ridge, spaced between the lower and upper ridges has an intermediate diameter that is less than the upper ridge diameter and not less than the lower ridge diameter. When the closure structures are made in strips, the upper ridges may have an upper joinder strip so that a plurality of structures can be manipulated at the same time. For example, an 8-channel pipette could pick and insert a strip of 8 closure structures joined together.

The workstation can be adapted to transfer, dispense, and aspirate liquid from one location to another automatically and optionally robotically in accordance with user programmed instructions. Fluid is dispensed and aspirated using the multi-function head having one or a selected plurality of nozzles associated with pipettes. Affixed to the nozzles are disposable pipettor tips, which are automatically picked up by the nozzles and ejected by a tip ejector mechanism that include a separate set of tips used to flush and wash the reaction vessels at the control of the user. The same nozzles used to dispense are used to transport novel ridged structures for microtiter plate well closures that seal the reaction vessels. A motor coupled to an actuator may be used to control the multiple functions including tip coupling fluid aspiration, fluid dispensing, tip ejection, and cover placement, sealing, and closure structure placement and removal. The workstation is designed for interactive connection with a remote computer.

### DESCRIPTION OF THE DRAWINGS

FIG. 1 is an isometric view of the well closure structures of the invention used with a multi-channel pipette and a multi-well plate.

FIG. 2 is an isometric view of the multi-channel pipette of FIG. 1 with well closure structures engaged.

FIG. 3 is a close up view of well closure structures attached to a multi-channel pipette.

FIG. 3a is a magnification of well closure structures attached to a lower portion of the multi-channel pipette of FIG. 3 at the circle E of FIG. 3.

FIG. 3b is a section of the well closure structures of FIG. 3a taken along lines G-G of FIG. 3a.

FIG. 4 is a close up side view of pipette well closure structures in wells of a multi-well plate.

FIG. 4a is a sectional view of the well closure structures of FIG. 4 taken along lines A-A in FIG. 4.

FIG. 5 is a front plan view of a well closure structures shown in FIG. 4a.

FIG. 5a is a perspective view of the well closure structures of FIG. 5.

FIG. 6 is a cross sectional view of the well closure structures of FIG. 5.

FIGS. 7, 8, and 9 are perspective view of successive steps for joinder of a strip of well closure structures to a multi-channel pipette and insertion into a multi-well plate.

FIG. 10 is a front plan view of a strip of well closure structures.

FIG. 11 is a cross sectional view of the strip of wells closure structures shown in FIG. 10.

### DETAILED DESCRIPTION

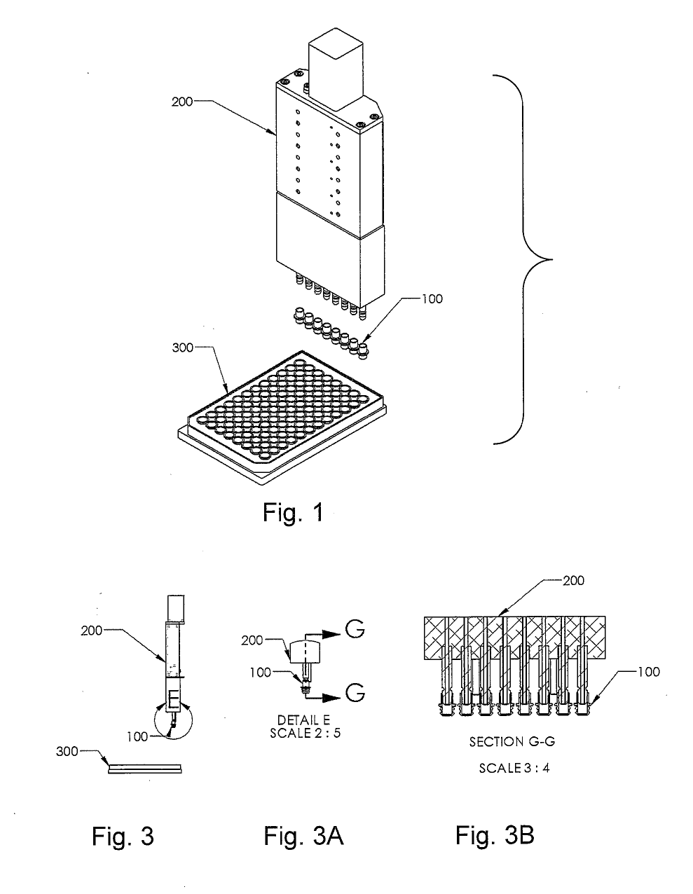

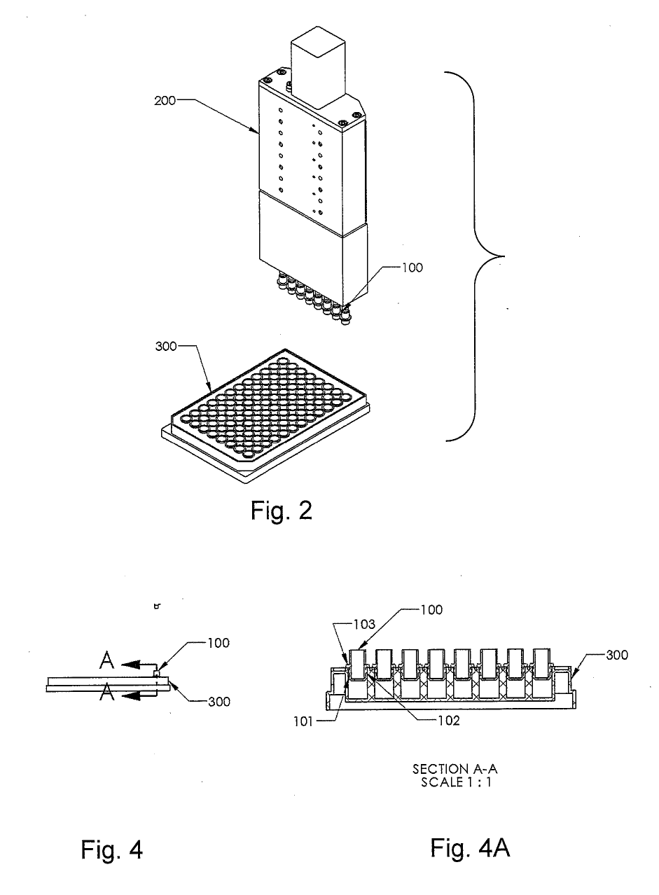

With reference to FIG. 1 a multi-channel pipette 200 engages a strip of well closure structures (“seals”) 100 that are designed to be transferred by the multi-channel pipette 200 from a storage container to a multi-well plate 300. The multi-channel pipette 200 picks up seals 100 by applying even force to the seals in the storage container as shown in FIG. 2. The pipette needs only to go halfway down the well to keep the seals secured. As an example, tips are placed firmly in 8 wells of a 96-well plate 300 as shown in FIGS. 3 and 4. Note the ridge seals 102 and 103 in FIG. 4a that will be described below.

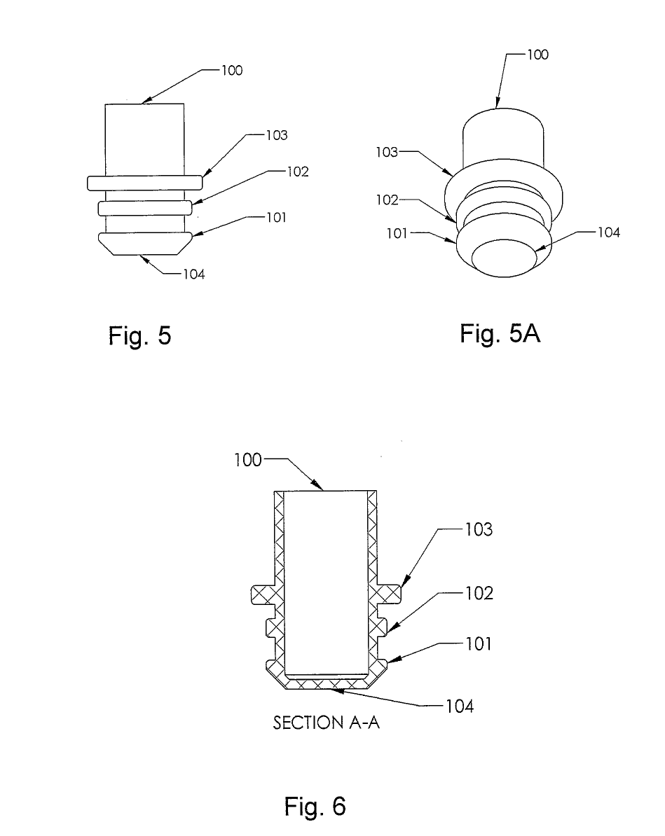

With reference to FIGS. 5, 5a, and 6 the function of the seal ridges 101 and 102 is to prevent evaporation and leakage of materials in the well. The ridges 101 and 102 on the thimble-shaped seal 100 firmly wedge the seal into the well. The seal ridge 103 being slightly wider than the well into which the seal is inserted stops the well seals from being pushed too far into the well. The ejection mechanism of the 8-channel pipette 200 of FIG. 1 can then be used to press against the seal ridge 103 to push the seal off the pipette while it remains in the well. The seals are made of firm rubber that provides a universal seal around the edge of the well. To extract the well seals vacuum produced by the 8-channel pipette 200 of FIG. 1 can be used to contact the seal ridge 103 to make removal possible. The vacuum from the 8-channel pipette 200 also improves the grip of the well seals 100 by the pipette.

The well seals completely seal off the well with the ridges 101, 102, and 103. Ridge 103 stops the well seal from penetrating too far into the well, but may allow slight penetration into the well since the ridge 13 has a very slightly larger diameter than the well to form a wedge fit, and provides a platform on which the ejection mechanism of the pipette 200 can apply force. The large ridge 103 acts as the upper seal and an ejection platform. Seals 101 and 102 provide additional seal security and ensure the well seal will stay in place. The bottom of the seal 104 will remain above any materials in the well. Ridge 101 has a beveled nose for self-centering insertion into a well taper outwardly to a diameter slightly small than the well diameter. The intermediate ridge 102 has about the same diameter as the well diameter.

In the cross section of FIG. 6 the inside of the well seal 100 is seen to have a hollow inside that is stopped or closed by the end of the seal 104. The top is open to allow access for the pipette to place and remove the seals. The seal is made of a yieldable, generally inert material such as rubber or a deformable polymer such as Neoprene. The structure should be self-supporting but not rigid, similar to washers used in plumbing.

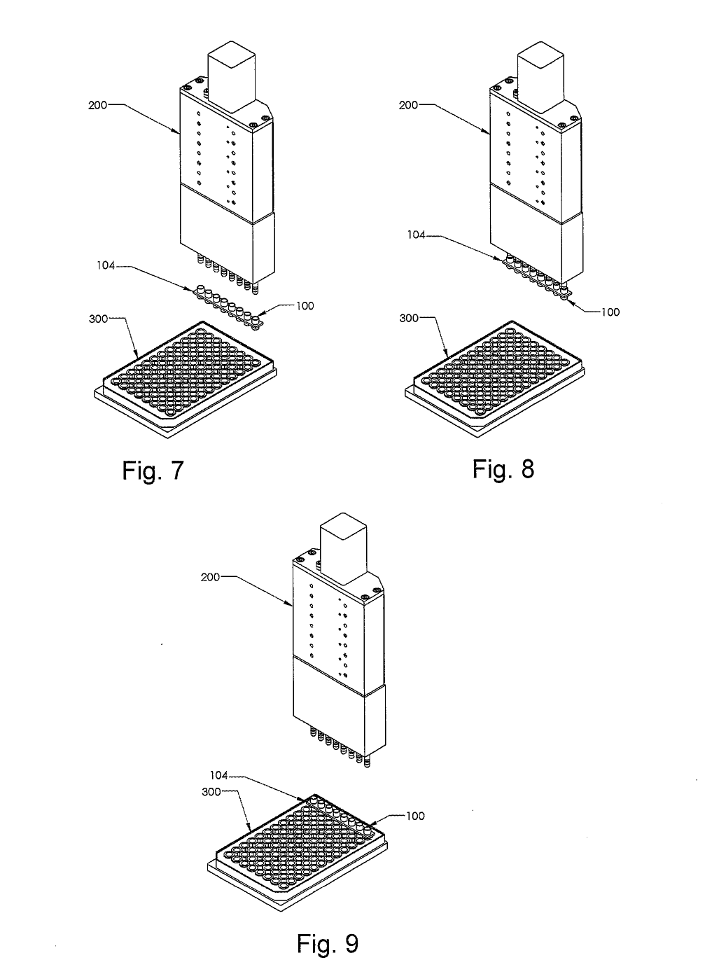

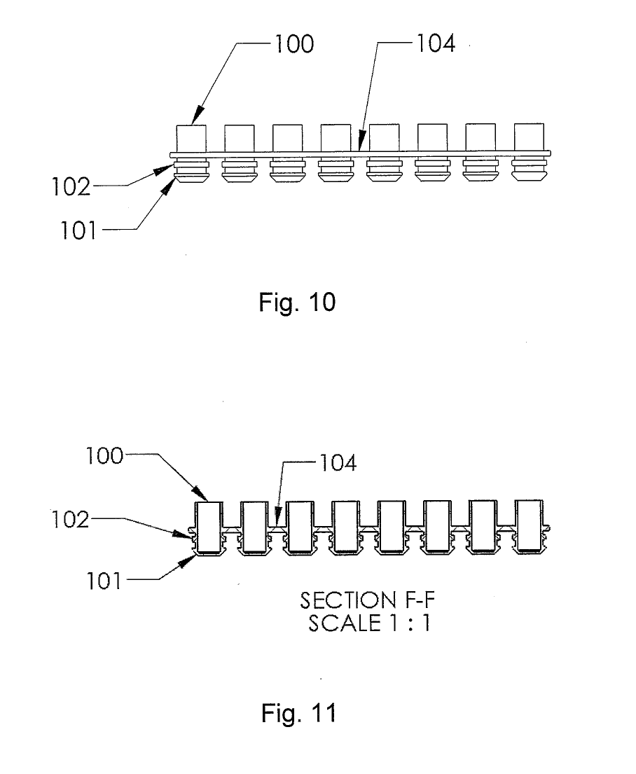

An alternative design consists of the well seals connected by a continuous strip of rubber 104 to form a well seal strip. This strip can be picked up and transferred with an 8-channel pipette to wells in the same manner as the well seals as shown in FIGS. 7-9. The strip prevents loss of well seals and promotes easy transfer and removal of seals.

What is claimed is:

1. In a pipette workstation of the type having a pipette loading reagents or samples into a microtiter plate, the improvement comprising:
a well closure structure comprising a thimble-shaped ridged structure with a closed downhole nose end smaller than a well diameter with a lower peripheral ridge that contacts walls of the well and an upper peripheral ridge having a diameter having a wedge fit into the well beyond a small diameter, the structure having a closed bottom and a open top, with the open top sized to accommodate a pipette nozzle.

2. The apparatus of claim 1 further comprising an intermediate ridge spaced from the lower and upper ridges and having a ridge diameter less than the upper ridge and not less than the lower ridge.

3. The apparatus of claim 1 wherein the downhole nose of the lower ridge is beveled.

4. The apparatus of claim 1 wherein the pipette workstation comprises a multi-channel pipette.

5. The apparatus of claim 1 wherein the pipette workstation comprises an 8-channel pipette.

6. The apparatus of claim 1 wherein the microtiter plate is a multi-well plate.

7. The apparatus of claim 1 wherein the microtiter plate is a 96-well plate.

8. The apparatus of claim 1 wherein each well closure structure is made of a yieldable material.

9. The apparatus of claim 1 wherein each well closure structure is made of rubber.

10. The apparatus of claim 1 wherein each well closure structure is made of a deformable polymer.

11. The apparatus of claim 1 further comprising a plurality of well closure structures connected along a continuous strip.

12. A method for sealing one or more wells of a well plate, comprising:
moving a pipette head having a nozzle array to a well seal array storage location, each well seal comprising a well closure structure comprising a thimble-shaped ridged structure with a closed downhole nose end smaller than a well diameter with a lower peripheral ridge that contacts walls of the well and an upper peripheral ridge having a diameter having a wedge fit into the well beyond a small diameter, the structure having a closed bottom and a open top, with the open top accommodating a pipette tip;
inserting each pipette nozzle into the open top of a well seal and attaching the well seal to the pipette nozzle;
moving the nozzle array with the attached well seals into wells of a microtiter plate; and
ejecting the well seals from the nozzle array, the upper peripheral ridge of each seal preventing the well seal from being pushed too far in the well.

13. The method of claim 12 further comprising moving the nozzle array to the sealed wells and using a vacuum force from the pipette head to remove the seals.
